(19) United States
(12) Patent Application Publication
(10) Pub. No.: US 2006/0216555 A1
(43) Pub. Date: Sep. 28, 2006

(54) Fuel cell system and method for removing residual fuel gas

(75) Inventors: Masahiro Shige, Toyota-shi (JP); Shigeto Kajiwara, Toyota-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/438,277

(22) Filed: May 23, 2006

Related U.S. Application Data
(63) Continuation of application No. PCT/JP05/02516, filed on Feb. 10, 2005.

(30) Foreign Application Priority Data
Feb. 12, 2004 (JP) 2004-035173

(51) Int. Cl. H01M 8/18

(52) U.S. Cl. 429/19; 429/13

(57) ABSTRACT

A fuel battery system capable of quickly consuming residual hydrogen gas even if a surplus power consumption means has a limitation. During shutdown of the system, a fuel battery (10) is made to generate power by using the surplus fuel gas to charge a secondary battery (41), and non-storable surplus power is consumed by consumption means (22, 33, 13). When the surplus power generated by the fuel cell is consumed by the consumption means, any limitation in the system is detected, and the power generated by the fuel battery is changed depending on the detected limitation.

### TECHNICAL FIELD

The present invention relates to a fuel cell system. More particularly, this invention relates to an improvement of a fuel cell system for consuming, by electric power generation, surplus fuel gas remaining in a fuel cell and gas pipes during shutdown.

### BACKGROUND ART

Fuel gas systems for consuming hydrogen gas remaining in pipes during shutdown by having a fuel cell generate electric power have already been developed. For example, JP-A-2001-229951 discloses a mobile fuel cell system for switching between charging a battery with electric power generated from residual hydrogen, and discharging to a discharging resistor.

Specifically speaking, when the voltage of the surplus electric power is sufficient to charge the battery and the battery will not overcharge, surplus electric power is used to charge the battery; and when the battery is fully charged or the voltage of the surplus electric power is not sufficient to charge the battery, surplus electric power is discharged to the discharging resistor.

According to the above-described known technique, it is possible to improve energy efficiency and rapidly reduce residual hydrogen concentration by switching between charging the battery and discharging to the discharging resistor during shutdown of the system.

### DISCLOSURE OF THE INVENTION

However, according to the related art described above, the amount of surplus electric power generated by the fuel cell is kept at a fixed amount and that can sometimes be inconvenient, depending on the status of the component consuming the surplus electric power. For example, assuming the means for consuming the electric power is motor machinery, since there are limitation(s), such as an NV (Nxxxxx Vxxxxxx) requirement, on motor machinery, there is the possibility that residual electric power that can not be used to charge the battery may not be consumed. In that case, the total sum of the electric power that can be consumed by charging the battery and by the motor machinery is not a fixed value, the generated electric power eventually decreases, and the residual hydrogen gas cannot be consumed in a short time.

Accordingly, it is an object of this invention to provide a fuel cell system capable of quickly removing residual hydrogen gas even if there is a limitation on a surplus power consumption means.

In order to achieve the above-described object, the invention provides a fuel cell system for reducing residual fuel gas during shutdown, wherein the fuel cell system supplies the residual fuel gas to a fuel cell and has a consumption means consume at least part of the surplus electric power generated by the fuel cell, and the fuel cell system is configured so that the power generation status of the fuel cell can be changed according to the operation status of the system.

Moreover, the invention includes: means for supplying residual fuel gas to a fuel cell during shutdown; consumption means for consuming at least part of the surplus electric power generated by the fuel cell; means for detecting the operation status of the system; and means for changing the power generation status of the fuel cell according to the detected operation status.

Furthermore, the invention provides a method for removing residual fuel gas in a fuel cell system for reducing residual fuel gas during shutdown, the method including the steps of: supplying residual fuel gas to a fuel cell during shutdown; having a consumption means consume at least part of the surplus electric power generated by the fuel cell; detecting the operation status of the system; and changing the power generation status of the fuel cell according to the detected operation status.

In the configuration described above, at least part of the surplus electric power generated by the fuel cell using residual fuel gas is consumed by the consumption means. Also, since the power generation status of the fuel gas is changed according to the operation status of the system, the residual fuel gas can be consumed by any consumption means in any condition, and the consumption control area can thereby be expanded.

The expression “during shutdown” means the state where the electric power generation (operation) of the fuel cell is stopped, and includes the case where an operation stop request is made during the operation of the fuel cell and the fuel cell temporarily stops operating.

The “fuel gas” means hydrogen gas in the narrow sense, but hereinafter also includes any oxidized gas, such as air, that is the oxygen source.

The “residual fuel gas” means the fuel gas remaining in the fuel cell (for example, in stack passages) or in fuel gas supply pipes connected to the fuel cell.

The “fuel cell system” or “system” means components for operating a fuel cell and includes, for example, a fuel cell (such as a fuel cell stack), fuel gas supply pipes and accompanying auxiliary machinery (such as pumps) for supplying the fuel gas to the fuel cell, oxidized gas supply pipes and accompanying auxiliary machinery (such as compressors) for supplying the oxidized gas to the fuel cell, cooling units for cooling the fuel cell (such as coolant pumps and cooling fans), and electric power units for storing and discharging electric energy from the fuel cell (such as a secondary battery, a capacitor, and voltage conversion devices (including a converter and an inverter)).

The expression “at least part of” includes the remaining electric power other than that consumed by the consumption means being, for example, stored by a secondary battery.

Various devices can be “consumption means.” Even if the consumption means has a limitation, the fuel gas consumption is controlled in this invention so that various consumption means can be used. Besides resistors, motor machinery such as compressors, pumps, traction motors, and auxiliary motors can also be used.

The “operation status of the system” can be understood by various physical values in the components constituting the system described above (including, those for the gas, its temperature, flow rate, pressure and so on; those for the auxiliary machinery, its number of revolutions, consumption power and so on; those for the cooling units, the number of pump revolutions, the temperature of the coolant, and so on; and those for the electric power units, their electric power, electric current, voltage, temperature, and so on).

The “power generation status of the fuel cell” includes, with regard to the output side of the fuel cell, elements such as the generated electric power, the generated electric current, and the generated voltage; and also includes, with regard to the input side of the fuel cell, the supply amounts of the fuel gas and oxidized gas, and elements that will result in an effect on the electric power generation by changing the operating conditions of the auxiliary machinery and valves, which are correlated with the above-mentioned supply amounts.

Preferably, the status of the system, where the power generation status of the fuel cell needs to be changed, is the status where the system operates under a limitation. Since in that configuration electric power generation is restrained only when the system has a limitation, it is possible to secure maximum power generating capacity as a whole and reduce the consumption time for the residual fuel gas.

The consumption means is, for example, the drive means for supplying the fuel gas to the fuel cell. It is preferable that the electric power to be generated by the fuel cell is changed based on a change in the amount of fuel gas supplied and the electric power consumed by the drive means. The drive means has limitations, such as a maximum electric current, depending on its characteristics. However, according to this invention, the limitation is detected and the electric power to be generated is changed according to the amount of electric power that can be consumed by the drive means.

The “change of the electric power” does not necessarily mean that the electric power value changes. Even if the electric power value itself is not changed, a change of an electric current value or a voltage value is considered a change of the electric power according to the invention.

It is also preferable that the drive amount of the drive means for supplying the fuel gas to the fuel cell is changed based on the changed value of electric power to be generated. If the amount of electric power to be generated by the fuel cell is changed, it is necessary to control the fuel cell so that it will generate the changed amount of electric power. In the above-described configuration, the drive amount of the drive means is adjusted and the electric power to be generated can thereby be adjusted too.

The electric power consumed by the consuming means as herein mentioned should ideally be the electric power equivalent to the surplus electric power generated by the fuel cell, excluding the electric power that can be used to charge the electric power storing device. This is because ideally, the electric power storing device is charged from any residual fuel gas, if possible, in order to effectively make use of the fuel gas. If the electric power storing device cannot be charged from the residual fuel gas, the consuming means may be used to consume the residual fuel gas in order to execute power limitation processing according to this invention.

Moreover, according to the invention, normal termination is executed where the pressure of the residual fuel gas has become equal to or less than a predetermined value due to the generation of electric power by the fuel cell. When the pressure of the residual fuel gas has become equal to or less than a predetermined value, it means that the residual fuel gas has been consumed sufficiently. Accordingly, if the fuel gas has been consumed sufficiently, the intended purpose is achieved and, therefore, the system is terminated normally. For example, the power generation by the fuel cell and the power consumption by the consuming means are stopped.

Furthermore, according to the invention, abnormal termination is executed where the pressure of the residual fuel gas has not become equal to or less than a predetermined value even after a specified period of time has elapsed. If the pressure of the residual fuel gas has not decreased for a long time, there is the possibility of a system abnormality of some sort. Accordingly, abnormal termination is executed. For example, it is possible to control the system in order to stop the fuel cell, and notify the user of any abnormality.

If the electric power storing device is provided, a specific example of a limitation according to this invention would be where a limitation is put on a charging current for the electric power storing device. In that system, the limitation on charging the electric power storing device is considered as the limitation. Accordingly, it is possible to protect the electric power storing device against overcharging and protect the voltage conversion device supplying the electric power (electric current) to the electric power storing device.

Incidentally, an electric power storing device limitation can be understood from physical values relating to factors that may disturb the electric power storing functions, such as the remaining chargeable amount, the temperature of the electric power storing device, and deterioration.

If the voltage conversion device is provided, another specific example of a limitation would be where a limitation is imposed depending on the temperature of the voltage conversion device. In that system, the temperature of the voltage conversion device is considered as the limitation. Accordingly, excessive heat generation due to a large amount of electric power passing through the voltage conversion device can be limited. Accordingly, it is possible to protect the components constituting the voltage conversion device.

A further example of a limitation would be where a limitation is imposed depending on the internal temperature of the fuel cell. In that system, the internal temperature of the fuel cell is considered as the limitation. Accordingly, it is possible to protect electrolytic films in the fuel cell against excessive heat generation.

A still further example of a limitation would be where a limitation is imposed depending on the voltage of the power generated by the fuel cell. In that system, the voltage of power generated by the fuel cell is considered as the limitation. Accordingly, if the voltage of the power generated by the cells constituting the fuel cell decreases, the electrolytic films of single cells can be protected by avoiding excessive heat generation.

If a compressor for supplying oxidized gas to the fuel cell is provided, a yet further example of a limitation would be where a limitation is put on the amount of oxidized gas supplied by the compressor. In that system, the amount of oxidized gas supplied by the compressor is considered as the limitation. Accordingly, it is possible to avoid excessive drying of the single cells in the fuel cell due to excessive supply of the oxidized gas, and to maintain durability of the single cells.

### BRIEF DESCRIPTION OF THE DRAWINGS

FIG. 1 is a block diagram of a fuel cell system according to an embodiment of this invention.

FIG. 2 is a flowchart explaining the electric current consumption method of the fuel cell system according to the embodiment.

FIG. 3 is a diagram showing the relationship between a current-voltage characteristic of the fuel cell and the electric power to be generated by the fuel cell.

FIG. 4 is a diagram of converter output characteristics.

FIG. 5 is a functional block diagram of the invention.

### BEST MODE FOR CARRYING OUT THE INVENTION

A preferred embodiment of the invention is described below with reference to the attached drawings.

The embodiment is a fuel cell system mounted on a mobile object such as an electric automobile, to which the electric power limitation method of the invention is applied. The embodiment described below is just one example of the invention, and the invention can be used without being limited to the following embodiment.

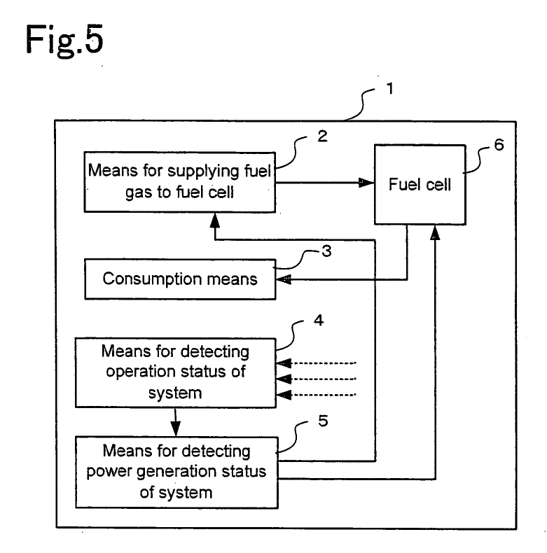

FIG. 5 shows functional blocks of the invention. As shown in FIG. 5, in a fuel cell system 1 according to the invention for having a fuel cell 6 generate electric power by using residual fuel gas during shutdown, a consumption means 3 is made to consume at least part of the surplus electric power generated as a result of power generation by the fuel cell 6. When the consumption means 3 is made to consume the electric power, the limitation in the system 1 is detected and the electric power to be generated is changed depending on the power generation status of the fuel cell 6 and according to the detected limitation.

As a more general description of the invention, the fuel cell system 1 includes: means 2 for supplying residual fuel gas to a fuel cell 6 during shutdown; the consumption means 3 for consuming at least part of the surplus electric power generated as a result of power generation by the fuel cell 6; means 4 for detecting the operation status of the system 1; and means 5 for changing the power generation status of the fuel cell according to the detected operation status. These functional blocks are realized by the following fuel cell system.

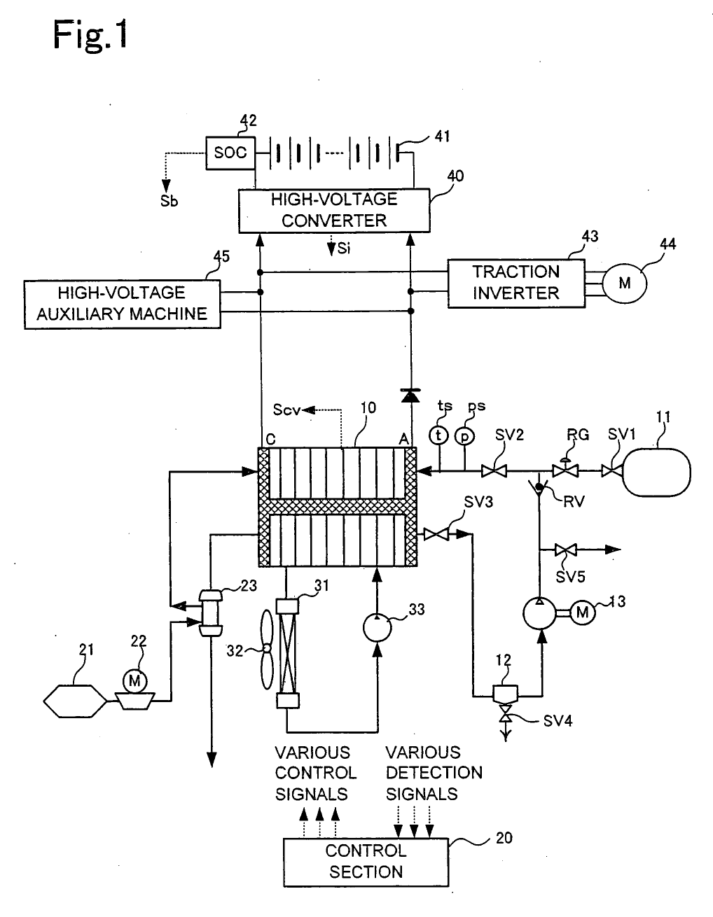

FIG. 1 is an overall system view of a fuel cell system according to the invention. As shown in FIG. 1, the fuel cell system includes a gas distribution system and an electric system. The gas distribution system includes a system for supplying hydrogen gas to a fuel cell stack 10, a system for supplying air, which is the oxygen source, and a system for cooling the fuel cell stack 10.

The fuel cell stack 10 has a stack configuration formed by stacking a plurality of cells where each cell is composed of: separators having passages for hydrogen gas, air, and cooling water; and an MEA (Membrane Electrode Assembly) held between a pair of separators. The MEA is configured in such a way that a polymer electrolytic film is held between two electrodes, a fuel electrode and an air electrode. The fuel electrode is formed by placing a fuel electrode catalyst layer over a porous support, while the air electrode is formed by placing an air electrode catalyst layer over a porous support. Since the fuel cell causes a reverse water electrolysis reaction, hydrogen gas is supplied via a hydrogen gas supply passage to the fuel electrode cathode, and gas (air) containing oxygen is supplied to the air electrode anode. The reaction in formula (1) happens on the fuel electrode side and the reaction in formula (2) happens on the air electrode side, thereby circulating electrons and passing an electric current.
H₂ →2H⁺+2e⁻ Formula (1)
2H⁺+2e⁻+(½)O₂→H₂O

As can be seen from the above formulas (1) and (2), not only the hydrogen gas, but also the air is the essential fuel gas that contributes to the generation of electric power.

The hydrogen gas supply system includes, along the hydrogen gas supply passage from a hydrogen tank 11 to the fuel cell stack 10, a stop valve SV1, a pressure regulating valve RG corresponding to the pressure adjusting means according to the invention, and a fuel cell inlet shutoff valve SV2. The hydrogen gas supply system also includes, along a circulation passage from the outlet of the fuel cell stack 10, a fuel cell outlet shutoff valve SV3, a gas-liquid separator 12, a shutoff valve SV4, a hydrogen pump 13, and a non-return valve RV. The downstream side of the hydrogen pump 13 is connected to an exhaust passage for hydrogen off-gas, and a purge shutoff valve SV5 is provided on the exhaust passage.

In this embodiment, the hydrogen gas supply system includes the circulation passage, but it may not necessarily include it. Also, the circulation passage may be connected to the upstream side of the pressure regulating valve RG. Moreover, the hydrogen gas supply system may include a recovery tank for storing hydrogen gas that cannot be consumed by the fuel cell stack 10.

The hydrogen tank 11 is filled with high-pressure hydrogen gas. Besides a high-pressure hydrogen gas tank, various tanks can be used as the hydrogen tank, such as a hydrogen tank made of hydrogen absorption alloy, a hydrogen supply mechanism using reformed gas, a liquefied hydrogen tank, and a liquid fuel tank. The stop valve SV1 is opened or closed according to a control signal from a control section 20, thereby selecting whether or not the hydrogen gas should be made to flow into the supply passage.

The pressure regulating valve RG maintains the hydrogen gas supply pressure of the circulation passage at a desired pressure value. The fuel cell inlet shutoff valve SV2 and the outlet shutoff valve SV3 are closed according to a control signal from the control section 20 after the hydrogen gas remaining in the circulation passage has been consumed, during shutdown of power generation by the fuel cell, by the operation according to the invention. The gas-liquid separator 12 removes moisture and other impurities generated by the electrochemical reaction of the fuel cell stack 10 during normal operation from the hydrogen gas, and discharges the moisture and other impurities to the outside through the shutoff valve SV4. The hydrogen pump 13 forces the hydrogen gas in the circulation passage to circulate according to the control signal from the control section 20. The hydrogen pump 13 is part of the consumption means of the fuel cell system. When hydrogen consumption control is conducted according to the invention, the hydrogen pump 13 circulates hydrogen gas and thereby operates to expedite the consumption of the hydrogen gas. The purge shutoff valve SV5 is connected to the circulation passage and is opened when purging. In addition, the purge shutoff valve SV5 is designed to discharge part of the hydrogen gas that cannot be used for power generation by the fuel cell stack 10. The hydrogen gas discharged from the purge shutoff valve SV5 is supplied to a dilution unit not shown in the drawing and then diluted with the discharged air.

A temperature sensor ts detects the operating temperature of the fuel cell stack 10. A pressure sensor ps detects the hydrogen gas supply pressure in the fuel cell stack 10. These sensors ts and ps respectively output the detected results as detection signals to the control section 20.

The air supply system includes an air cleaner 21, a compressor 22, and a humidifier 23. The air cleaner 21 cleans and introduces outside air into the fuel cell system. The compressor 22 is part of the consumption means of the fuel cell system according to the invention and is designed to change the quantity and pressure of air supplied to the fuel cell stack 10 by compressing the introduced air according to a control signal from the control section 20. The humidifier 23 adds an appropriate degree of humidity by exchanging moisture between the compressed air and the discharged air.

The cooling system for the fuel cell stack 10 includes a radiator 31, a fan 32, and a cooling pump 33, and is designed to circulate cooling water inside the fuel cell stack 10. The fan 32 equipped with a motor not shown in the drawing, and the cooling pump 33 are also parts of the consumption means according to the invention.

Next, the electric system will be described. In the fuel cell stack 10, single cells are connected in series or parallel with each other and, therefore, a specified high voltage (for example, approximately 500V) is produced between anode A and cathode C. A high-voltage converter 40 performs voltage conversion for a secondary battery 41 having a different voltage in order to utilize the power of the secondary battery 41 as an auxiliary power source for the fuel cell stack 10, and also performs voltage conversion in order to charge the secondary battery 41 with surplus electric power from the fuel cell stack 10. A battery computer 42 is designed to monitor the charge state of the secondary battery 41 regularly or upon request and output the charge state to the control section 20. A traction inverter 43 converts direct current into three-phase alternating current and supplies it to a traction motor 44. The traction motor 44 is also part of the consumption means according to the invention. A high-voltage auxiliary machine (fuel cell auxiliary machine) 45 is motor machinery for the hydrogen pump 13, the fan 3, the cooling water pump 33, and the like.

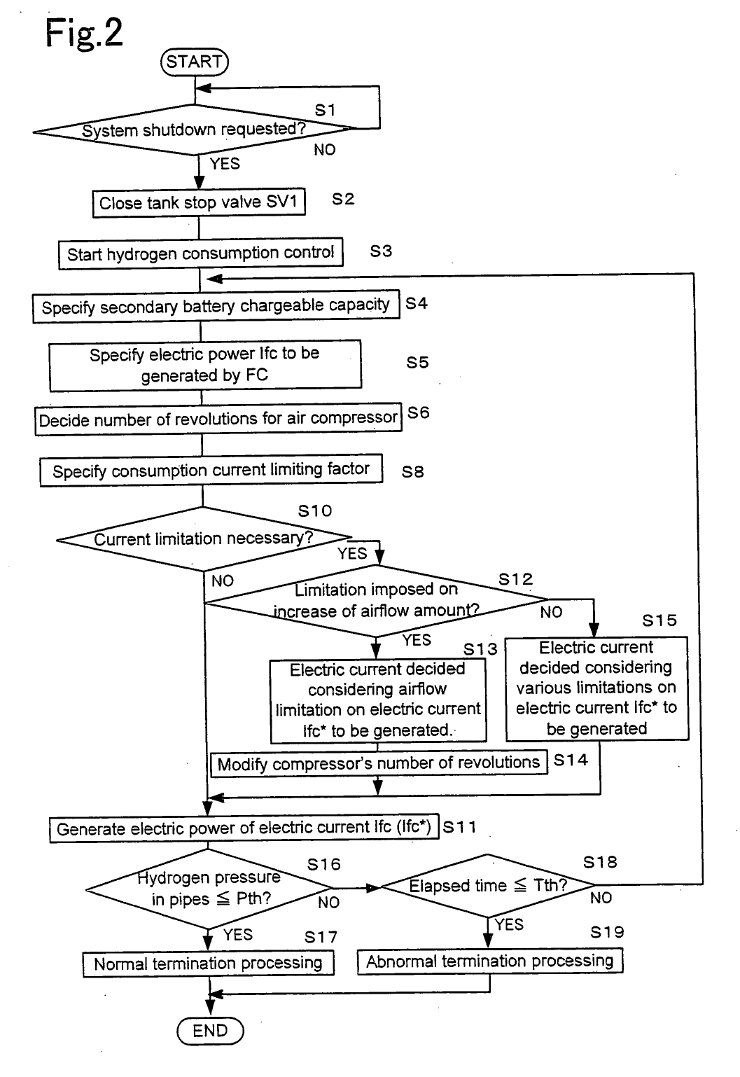

The control section 20 is a known computer system such as an ECU (Electronic Control Unit) and can implement the residual fuel gas reducing method according to the invention by having a CPU (Central Processing Unit), not shown in the drawing, sequentially execute software programs stored on a ROM or similar, also not shown in the drawing. Specifically speaking, according to the procedure described later (FIG. 2), the control section 20 operates to have the high-pressure auxiliary machine 45 consume the surplus electric power during shutdown, detect the limitation of the system at that time, and change the electric energy to be generated by the fuel cell stack 10 according to the detected limitation.

Now, the operation of the fuel cell system according to this embodiment will be described below with reference to the flowchart in FIG. 2. When the fuel cell system is in operation, the processing explained by this flowchart is repeatedly executed at appropriate intervals while the power source is on.

This fuel cell system is configured to execute the residual fuel gas reduction processing according to the invention. Specifically speaking, the fuel cell system supplies hydrogen gas remaining in the circulation passage during shutdown to the fuel cell stack 10 and has it consume the hydrogen gas, uses the surplus electric power generated to charge the secondary battery 41, and consumes part of the surplus electric power that cannot be used for charging the battery by driving the traction motor 44, the compressor 22, the fan 32, the cooling pump 33, and the hydrogen pump 13, which are the consumption means. When this happens, the fuel cell system sets the maximum electric energy according to the operation status of the system, and detects whether the system has a limitation, such as an electric current limitation; and if the system has a limitation, the electric energy generated by the fuel cell stack 10 is changed according to that limitation.

The control section 20 first checks whether the fuel cell system has been directed to shut down (S1). If shutdown has not been requested (S1: NO), the control section 20 continues the other operations for the fuel cell system.

If shutdown has been requested (S1: YES), the control section 20 starts a shutdown sequence for the system. The control section 20 first outputs a control signal to close the stop valve SV1 of the hydrogen tank 11 (S2) and stops the supply of new hydrogen gas, and then starts hydrogen consumption control according to the invention in order to consume the hydrogen gas remaining in the circulation passage (S3).

The control section 20 first specifies the chargeable electric capacity of the secondary battery 41, based on information from the battery computer 42 (S4). The control section 20 determines, according to this power capacity, which destination the surplus electric power generated by the hydrogen consumption control according to the invention should be distributed to.

The control section then specifies an electric current Ifc to be generated by the fuel cell stack 10 (S5). This generated electric current Ifc can be decided in the manner described below. Where Pfc represents the electric power to be generated by the fuel cell stack 10, Pb represents the chargeable power capacity of the secondary battery 41, and Pc represents the electric power to be consumed by the high-voltage auxiliary machine 45, the relationship between them is described by the following formula (3).
Pfc=Pb+Pc Formula (3)
Since the electric power Pc to be consumed by the high-voltage auxiliary machine 45 is decided unambiguously according to the control signal output from the control section 20, it is possible to calculate the consumed electric power Pc by summing up the consumed electric power corresponding to the number of revolutions of each auxiliary machine. As the chargeable power capacity Pb of the secondary battery 41 was detected in step S4, the electric power Pfc to be generated by the fuel cell stack 10 is decided by adding the power capacity Pb and the electric power Pc to be consumed by the auxiliary machines.

Subsequently, the control section 20 sets the electric power Pfc to be generated, at as large a value as possible, by assuming there is no particular limitation such as an electric current limitation. This is because the residual hydrogen gas can be consumed faster when larger electric power is generated. It should be noted that if the number of revolutions of the compressor 22 and the hydrogen pump 13 is increased, the electric power consumed by the auxiliary machines will increase and, along with it, the electric power generated by the fuel cell stack 10 will also increase. Therefore, the appropriate number of revolutions of the compressor 22 and the hydrogen pump 13 is decided temporarily and the electric power to be generated at that number of revolutions is set as the electric power Pfc to be generated. If the right-hand side of formula (3) becomes smaller than the left-hand side, the charge power for the secondary battery is reduced. If the right-hand side of formula (3) becomes larger than the left-hand side, the auxiliary machines, such as the traction motor 44, the cooling pump 33, and the fan 22, that will not influence the electric energy generated are selected to consume the electric power, and the number of revolutions for those auxiliary machines is decided.

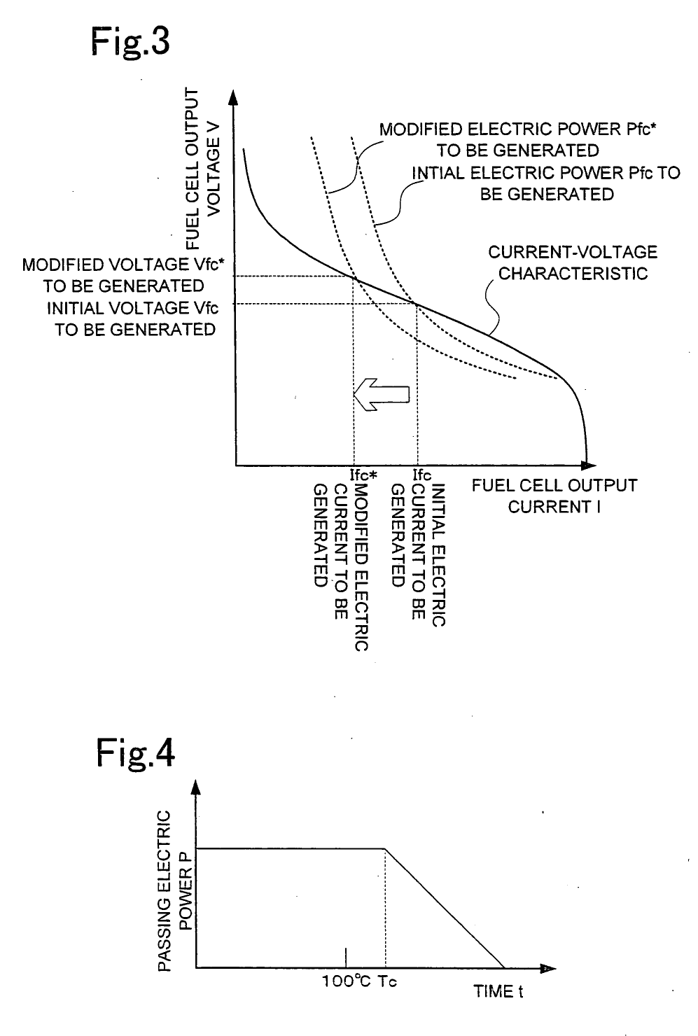

FIG. 3 is a current-voltage (IV) characteristic showing the relationship between a piezoelectric current that is a power generation characteristic of the fuel cell, and the generated voltage. The control section 20 stores, as a data table, the current-voltage characteristic for the fuel cell stack 10. The control section 20 decides the electric current Ifc to be generated, based on the curve defined by the temporarily decided electric power Pfc to be generated, and the current-voltage characteristic of the fuel cell stack 10. Specifically speaking, the electric current Ifc is decided by finding a point of intersection between the electric power Pfc curve and the IV curve, and the decided electric current is then specified as the initial electric current Ifc to be generated. The control section 20 decides the number of revolutions for the compressor 22 so that the electric power Pfc temporarily decided above will be generated and the electric power consumed will be within the range of the generated electric power Pfc (S6).

If there is no limitation on the electric power to be generated, the consumption of the residual hydrogen is executed by setting voltages of both terminals of the fuel cell stack 10 to the voltage Vfc for power generation at the electric current Ifc. However, according to the invention, the consumed current limiting factor for changing the electric power to be generated, that is, for changing the electric current to be generated is specified depending on whether or not the high-voltage auxiliary machine 45 (S8) has an electric current limitation.

As this consumed current restricting factor, a limitation may be put on a charging current for the secondary battery 41. Normally, the more the electric current is increased, the faster the battery charging can be completed. However, if the power flowing through the high-voltage converter 40 is too large, or if the battery computer 42 requests a limitation on the charging current due to deterioration or other circumstances, the generated electric current should be reduced to the limited current. Therefore, the control section 20 checks whether or not the battery computer 42 has put a limitation on the charging current.

Moreover, as shown in FIG. 4, when the temperature increases to a certain degree (Tc), the value of electric power that can flow through the high-voltage converter 40 decreases due to the operating characteristics of a switching element and loss caused by a reactor. A module for controlling the operation of the high-voltage converter 40 detects the temperature inside the converter; and if the temperature is higher than a specified threshold value Tc, the module may make a request to the control section 20 to put a limitation on the flowing electric power. Accordingly, even if the secondary battery 41 has sufficient chargeable power capacity and can be charged with a high current, if the temperature of the high-voltage converter 40 is high, the flowing electric current may need to be limited from the viewpoint of element protection. Therefore, the control section 20 checks whether or not the high-voltage converter 40 has requested flowing electric power control.

Furthermore, if the internal temperature of the fuel cell stack 10 is too high, the electric power to be generated may need to be limited from the viewpoint of protection of the electrolytic films. Therefore, the control section 20 detects the internal temperature of the fuel cell stack 10 according to a detection signal from the temperature sensor ts and specifies whether or not the temperature is within the range enabling proper power generation.

If any of the single cells in the fuel cell stack 10 has deteriorated, the voltage of electric power generated by that single cell decreases. If high power is generated under such circumstances, this may hasten deterioration of the electrolytic films on the single cells. Therefore, the control section 20 monitors the voltage(s) of one or more single cells in the fuel cell stack 10 according to a detection signal Scv; and if decrease in a single cell voltage is observed, the maximum electric power to be generated is limited to a specified value or less.

There is also another case where the electric power to be generated needs to be reduced, although it is not where there is a limitation on the amount of current (electric energy) that can flow directly. It is done by the operation of the compressor 22 for supplying air. If the number of revolutions of the compressor 22 increases and the air amount becomes too much, the single cells in the fuel cell stack 10 dry out and the durability of the single cells is reduced. Also, this is clashes with the NV requirement, and noise and vibration may occur. Particularly, in the case of power generation for hydrogen consumption after shutdown, the amount of moisture generated on the air electrode side may sometimes decrease due to a reduction of the load amount. Therefore, if the air amount becomes excessive, the number of revolutions of the compressor 22 needs to be decreased and the electric power to be generated needs to be changed accordingly.

If no current (power) limitation is confirmed by the verification processing described above (S10: NO), power can be generated at the electric power Pfc and the electric current Ifc as set in step S5. Therefore, the control section 20 changes the voltage of the secondary-battery-side terminal of the high-voltage converter 40 to the voltage Vfc to be generated and has the fuel cell stack 10 generate power at the electric current Ifc (S11).

On the other hand, if there is any current (power) limitation (S10: YES) and if the limitation influences the number of revolutions of the compressor 22 (S12: YES), the control section 20 outputs a control signal for reducing the number of revolutions for the compressor 22 according to the limitation (S13) and modifies the number of revolutions for the compressor 22. The control section 20 sets the electric power to be generated by a new number of revolutions for the compressor 22 as the modified electric power Pfc* to be generated (S14).

If there is any current (power) limitation (S10: YES) and if the limitation relates to any factor other than the number of revolutions for the compressor 22 (S12: NO), the control section 20 modifies the electric current Ifc to be generated according to the current (power) limitation on each component of the system and sets the modified electric current as the new electric current Ifc* to be generated (S15).

As shown in FIG. 3, if the maximum current is determined directly depending on the limitation state, that current will be the new current Ifc* to be generated and a voltage corresponding to that current value with regard to the current-voltage characteristic will be the modified voltage Vfc* to be generated. If the power to be generated is to be changed, the control section 20 finds a new point of intersection between the curve indicating the modified current Ifc* to be generated and the current-voltage characteristic, and then determines the modified current Ifc* and the modified voltage Vfc*. The control section 20 outputs the control signal to the high-voltage converter 40 in order to apply the voltage Vfc* as the voltage of the secondary-battery-side terminal, and power generation starts by applying the modified current Ifc* (S11).

The hydrogen gas remaining in the circulation passage should be consumed by the above-described processing, and the pressure within the pipes should decrease gradually. If the pressure does not decrease, it is an abnormal situation, with the possibility of a sensor failure or a failure of the hydrogen consumption processing.

Therefore, the control section refers to the detection signal from the pressure sensor ps and checks if the hydrogen pressure in the pipes is equal to or less than a specified threshold value Pth (S16). If the hydrogen pressure is equal to or less than the specified threshold value Pth as expected (YES), it indicates that the hydrogen consumption has been conducted normally and, therefore, normal termination processing is executed (S17). Specifically speaking, the control section 20 stops the operation of the system by outputting a control signal to stop the operation of all the auxiliary machines and close the shutoff valves.

If the hydrogen pressure in the pipes is higher than the threshold value Pth (S16: NO) and an elapsed time Tth has not elapsed (S18: NO), it is a situation where the hydrogen consumption processing should be continued. Therefore, the processing returns again to the hydrogen consumption processing at step S4 and subsequent steps.

On the other hand, if the hydrogen pressure in the pipes has not been lowered even when the specified elapsed time Tth or a longer time has elapsed (S18: YES), it means that the pressure in the pipes has not been decreased sufficiently, and indicates a sensor abnormality or system abnormality. In that case the gas might have, for example, leaked out of the stop valve SV1 of the hydrogen tank 11. Therefore, the control section 20 executes notification processing, for example, by turning on a warning lamp, and, if possible, opens the purge shutoff valve SV5 to discharge the hydrogen gas from the circulation passage. At the same time, the control section 20 drives the compressor 22 to increase the air amount used for dilution of the hydrogen off-gas. If the pressure inside the pipes decreases after a certain period of time, or when a certain period of time has elapsed any way, the control section 20 closes all the shutoff valves and stops the operation of the auxiliary machines, thereby stopping the system.

According to the embodiment described above, electric power excluding the power that can be used to charge the secondary battery 41 is consumed by the high-voltage auxiliary machine 45. When this happens, whether or not each component of the system has a current (power) limitation is judged, and then the electric power to be generated by the fuel cell stack 10 is changed accordingly. Therefore, the residual gas can be consumed quickly by any object consuming the surplus electric power, thereby enabling expansion of the consumption control area. Moreover, since the electric power to be generated is limited only when a limitation exists, it is possible to secure maximum power generating capacity as a whole, and shorten the time for consumption of the residual fuel gas.

In other words, larger values can be set as the initial electric power and the initial electric current; and the electric current (power) may be changed if any limitation becomes evident during the hydrogen consumption processing. When the limitation no longer exists, the electric current (power) may be changed back to the original values. In this way, the maximum of hydrogen can be consumed, depending on the situation. Accordingly, it is possible to consume the residual hydrogen very quickly.

The present invention is not limited to the embodiment described above, and can be implemented with changes in various ways. For example, the aforementioned hydrogen consumption processing can be utilized to detect leakage of the hydrogen gas from the pipes and detect leakage from the stop valve SV1 of the hydrogen tank.

Once the electric current Ifc* to be generated by the fuel cell stack 10 is decided, the hydrogen gas consumption amount can be estimated. On the other hand, if a reduction in the pressure of hydrogen gas is monitored regularly by the pressure sensor ps, the actual hydrogen gas consumption amount can be found. Gas leakage can be detected by comparing these consumption amounts. Specifically speaking, if gas has leaked out of the pipes, the hydrogen gas consumption amount actually measured by the pressure sensor ps will become larger than the hydrogen gas consumption amount estimated from the electric current Ifc to be generated. Moreover, if gas has leaked out of the stop valve SV1 of the hydrogen tank 11, decrease in the pressure inside the pipes will hardly be evident and, therefore, the estimated hydrogen gas consumption amount will become larger than the hydrogen gas consumption amount obtained by actual measurement of the decrease in the pressure. Judgment on whether normal termination or abnormal termination should be executed may be decided by performing the processing described above at the end of the hydrogen consumption processing.

### INDUSTRIAL APPLICABILITY

If there is not sufficient electric energy to be consumed by the consuming means due to the existence of a consuming means limitation, the electric power to be generated by the fuel cell is accordingly changed according to the present invention. Therefore, the residual fuel gas can be consumed by any consuming means under any condition, and the consumption control area can be thereby expanded. Moreover, since the electric power to be generated is limited only when a limitation exists, it is possible to secure maximum power generating capacity as a whole, and shorten the time for consumption of the residual gas.

1.-15. (canceled)

16. A fuel cell system for reducing residual fuel gas during shutdown, the fuel cell system characterized in that:
the fuel cell system supplies the residual fuel gas to a fuel cell;
charges a part of surplus electric power generated by the fuel cell on an electric power storing device; and
consumes the other part of the surplus electric power by a consuming means,
wherein power generation status of the fuel cell can be changed according to a limitation of a device which generates or consumes electric power in the system.

17. The fuel cell system according to claim 16,
wherein the limitation of the device is a limitation in the consuming device.

18. The fuel cell system according to claim 16,
wherein the limitation of use of the device is a limitation in a voltage conversion device.

19. The fuel cell system according to claim 16,
wherein the limitation of use of the device is a limitation in the fuel cell.

20. The fuel cell system according to claim 17,
Wherein the consuming device is a drive motor, a compressor, a fan, a cooling pump, or a motor for a fuel gas pump.

21. The fuel cell system according to claim 17,
wherein the consumption means is drive means for supplying fuel gas to the fuel cell,
wherein electric power to be generated by the fuel cell is changed based on a change in a supply amount of the fuel cell by the drive means and the electric power consumed by the drive means.

22. The fuel cell system according to claim 16,
wherein drive amount of drive means for supplying the fuel gas to the fuel cell is changed based on changed value of electric power to be generated.

23. The fuel cell system according to claim 16,
wherein the electric power consumed by the consumption means is electric power equivalent to the surplus electric power generated by the fuel cell, excluding electric power that can be used to charge an electric power storing device.

24. The fuel cell system according to claim 16,
wherein normal termination is executed when pressure of the residual fuel gas has become equal to or less than a specified value due to the generation of electric power by the fuel cell.

25. The fuel cell system according to claim 16,
wherein abnormal termination is executed when pressure of the residual fuel gas has not become equal to or less than a specified value even after a specified period of time has elapsed.

26. The fuel cell system according to claim 18,
wherein the limitation in the voltage conversion device is imposed depending on temperature of the voltage conversion device.

27. The fuel cell system according to claim 19,
wherein the limitation in the fuel cell is imposed depending on internal temperature of the fuel cell.

28. The fuel cell system according to claim 19,
wherein the limitation in the fuel cell is imposed depending on voltage of the power generated by the fuel cell.

29. The fuel cell system according to claim 17, comprising a compressor for supplying oxidized gas to the fuel cell,
wherein the limitation in the consuming device is imposed on amount of oxidized gas supplied by the compressor.

30. The fuel cell system according to claim 16, wherein changing the power generating status of the fuel cell is changing electric current output from the fuel cell.

31. A fuel cell system comprising:
means for supplying residual fuel gas to a fuel cell during shutdown;
consumption means for consuming at least part of surplus electric power generated by the fuel cell;
means for detecting operation status of the system; and
means for changing power generation status of the fuel cell according to the detected operation status.

32. A method for removing residual fuel gas in a fuel cell system, for reducing residual fuel gas during shutdown,
the method comprising the steps of:
supplying residual fuel gas to a fuel cell during shutdown;
charging a part of surplus electric power generated by the fuel cell;
consuming the other part of surplus electric power generated by the fuel cell;
detecting operation status of the system; and
changing power generating status of the fuel cell according to the detected operation status.
